(19) United States
(12) Patent Application Publication
(10) Pub. No.: US 2025/0171086 A1
(43) Pub. Date: May 29, 2025

(54) BULKHEAD FOR FRONT-END VEHICLE STRUCTURE

(71) Applicant: GF Casting Solutions AG, Schaffhausen (CH)

(72) Inventors: Fabian Kohlbrenner, Höchenschwand (DE); Stephan Philipp, Gailingen (DE)

(21) Appl. No.: 18/963,568

(22) Filed: Nov. 28, 2024

(30) Foreign Application Priority Data
Nov. 29, 2023 (EP) 23212843.9

(51) Int. Cl. B62D 25/08; B62D 21/02; B62D 29/00

(52) U.S. Cl. CPC B62D 25/08; B62D 21/02; B62D 29/00

(57) ABSTRACT

A bulkhead of a motor vehicle, wherein the bulkhead extends transversely to a vehicle direction and is configured to separate a passenger compartment and a front compartment, the bulkhead including an upper cross member, and two inner A-pillars which are arranged in each case to a side of the bulkhead. The bulkhead further includes sill receiving elements and longitudinal member receiving elements which are arranged in each case on the inner A-pillars, and a lower cross member, the lower cross member and the bulkhead being configured as a one-piece or integral light metal pressure die-cast part.

### CROSS REFERENCE TO RELATED APPLICATIONS

This application claims benefit to European Patent Application No. EP 23212843.9 filed on Nov. 29, 2023, which is hereby incorporated by reference herein.

### FIELD

The invention relates to a bulkhead of a motor vehicle and a method for the production thereof.

### BACKGROUND

DE 10 2008 062 007 A1 discloses a bulkhead partition which is configured in multiple pieces, namely from a lower cross member, a bulkhead partition element and an upper reinforcing member, wherein the lower cross member is configured as a light metal pressure die-cast component and the bulkhead partition element and the upper reinforcing member are configured from a light metal sheet. The elements are connected together, for example, by welding, screwing, adhesive bonding or even clinching.

A drawback here is the high degree of effort for connecting the individual parts to one another.

DE 10 2008 062 004 A1 discloses a body structure in which the bulkhead partition has a flange and is connected to the cross member which also has a flange. Wherein the bulkhead partition is configured from a light metal sheet and is preferably welded or adhesively bonded to the cross member. There is also the drawback here of the significant time taken in bringing the individual elements together before the body structure part can be installed in the vehicle body.

EP 409 916 A1 discloses a one-piece structural component which exhibits a transversely running bulkhead with A-pillars arranged thereon to the side. A drawback here is that a lower cross member still has to be joined separately to the one-piece structural component.

### SUMMARY

In an embodiment, the present disclosure provides a bulkhead of a motor vehicle, wherein the bulkhead extends transversely to a vehicle direction and is configured to separate a passenger compartment and a front compartment, the bulkhead comprising an upper cross member, and two inner A-pillars which are arranged in each case to a side of the bulkhead. The bulkhead further comprises sill receiving elements and longitudinal member receiving elements which are arranged in each case on the inner A-pillars, and a lower cross member, the lower cross member and the bulkhead being configured as a one-piece or integral light metal pressure die-cast part.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a three-dimensional view of a bulkhead according to an embodiment of the invention viewed from a front compartment;

FIG. 2 shows a three-dimensional view of a bulkhead according to an embodiment of the invention viewed from a passenger compartment;

FIG. 3 shows a detail of a side view of a lower region of an inner A-pillar; and

FIG. 4 shows a view from below of a bulkhead according to an embodiment of the invention.

### DETAILED DESCRIPTION

In an embodiment, the present invention provides a bulkhead and a method associated therewith which shortens the production time, reduces logistics expenses and requires as few manual working steps as possible, whereby the cost-effectiveness of the part is designed to be increased and the bulkhead has a weight which is as low as possible.

The foregoing advantages are achieved by a bulkhead having a lower cross member and the bulkhead being configured as a one-piece or integral light metal pressure die-cast part.

The bulkhead according to an embodiment of the invention, preferably the bulkhead for a front-end vehicle structure of a motor vehicle, extends transversely to the vehicle direction and serves for the separation of the passenger compartment and the front compartment, preferably the engine compartment. The bulkhead according to an embodiment of the invention has an upper cross member, two inner A-pillars which are arranged in each case to the side of the bulkhead and receiving elements for the sill and the longitudinal member which are arranged in each case in the lower region on the inner A-pillars. Preferably, the inner A-pillars are configured mirror-symmetrically. The bulkhead also has a lower cross member. The elements such as the inner A-pillars, upper and lower cross members, receiving elements on the sills and the longitudinal members require no joining processes in order to be connected to one another to form a bulkhead, but the bulkhead according to an embodiment of the invention is configured as a whole. The bulkhead according to an embodiment of the invention is configured as a one-piece or integral light metal pressure die-cast part which permits a thin-walled construction and nevertheless achieves the desired stability.

It has been shown to be advantageous if at least one diagonal rib is arranged between the sill receiving element and the longitudinal member receiving elements. This serves for protecting the passenger compartment since in the event of a front impact the force is diverted from the longitudinal member into the sill via the diagonal rib. Preferably, two to three diagonal ribs are arranged on an inner A-pillar between the sill receiving element and the longitudinal member receiving elements.

In a preferred embodiment, the lower cross member is configured for attaching a battery housing. Preferably, corresponding attachment elements, such as for example screwing points, are arranged in the light metal pressure die-cast component in order to attach a battery housing to the lower cross member by joining.

Preferably, the lower cross member is configured for attaching a chassis sub-frame. Preferably, corresponding attachment elements, such as for example screwing points, are arranged in the light metal pressure die-cast component in order to attach a chassis sub-frame to the lower cross member by joining. Naturally different and further attachment points can also be integrated in the bulkhead, depending on the vehicle type.

It is advantageous if the receiving element is configured to be C-shaped, the sill and/or the longitudinal member being positively enclosed thereby. The C-shape of the receiving element also serves as a guide for the sill and/or longitudinal member.

It is advantageous if the bulkhead is configured to be thin-walled, wherein the component wall is between 1 and 8 mm, preferably between 2 and 5 mm. Preferably, the component walls have different thicknesses corresponding to their positioning on the bulkhead. Due to the different thicknesses of the component walls, the flow behaviour in the bulkhead is optimized or an optimized filling can be achieved. On the one hand, the individual component walls can have different thicknesses corresponding to their arrangement and, on the other hand, a component wall itself can also have different thicknesses, i.e. it can be tapered or widened in order to achieve an optimized filling as mentioned above.

A preferred embodiment of the bulkhead has ribbing for reinforcement on the lower cross member. Preferably, the ribbing is arranged on either side of the lower cross member, i.e. in the direction of the passenger compartment and in the direction of the front compartment. It is advantageous if the ribs extend obliquely from top to bottom over the entire lower cross member. Preferably, the ribs are distributed so as to extend at regular or irregular intervals over the entire length of the lower cross member.

Preferably, the upper cross member has ribbing for the reinforcement. The ribs are preferably oriented on the upper cross member toward the passenger compartment interior. It is advantageous if the ribbing extends over the entire length of the upper cross member, i.e. from the one inner A-pillar to the opposing inner A-pillar. Preferably, the ribs are configured in the manner of a cross.

According to a preferred embodiment, the bulkhead is produced from an Al or Mg alloy.

The foregoing is achieved according to an embodiment of the invention by the bulkhead being produced in a pressure die-casting method. A complex, thin-walled and yet stable shape is provided by the production of the bulkhead in a pressure die-casting method. Various attachments can also be integrated directly in the one-piece bulkhead, whereby additional assembly steps are avoided.

It has been shown to be advantageous if the bulkhead is subjected to heat treatment after casting. The desired properties, such as for example the expansion of the material of the bulkhead, are increased thereby. A heat treatment can take place in the entire piece or only partially.

All of the embodiments are able to be freely combined together and, in order to avoid repetition, the features of the device can also automatically refer to the method and vice versa.

An exemplary embodiment of the invention is described by way of the figures, wherein the invention is not only limited to the exemplary embodiment.

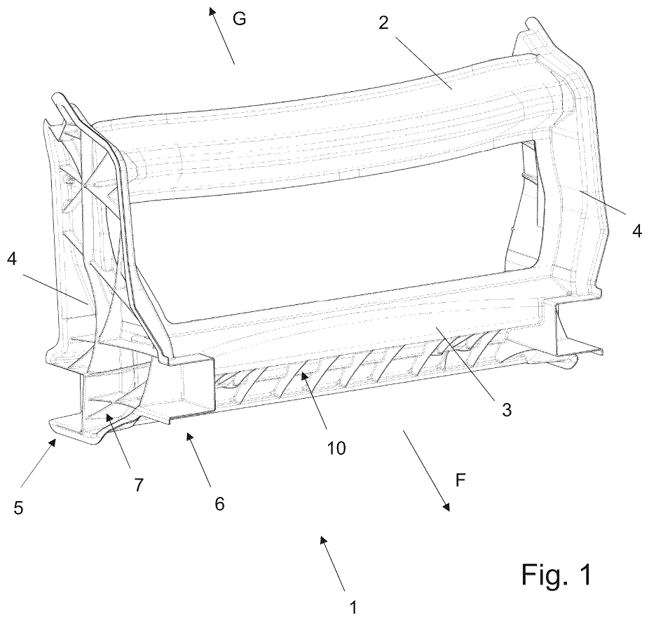

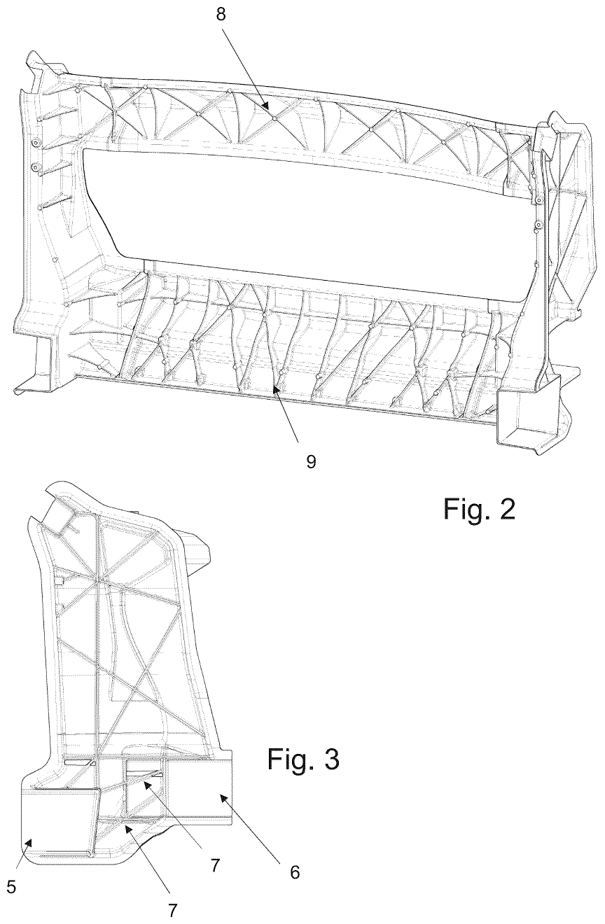

The drawing shown in FIG. 1 shows a bulkhead 1 according to an embodiment of the invention of a motor vehicle. The bulkhead 1 is configured as a one-piece or integral light metal pressure die-cast part. The bulkhead 1 contains an upper cross member 2 and inner A-pillars 4 arranged to the side thereof and a lower cross member 3. Receiving elements 5, 6 for the sill and the longitudinal member are integrally arranged in the lower region of the inner A-pillars 4 or are also integrated in the pressure die-cast bulkhead 1 according to the present disclosure. It is advantageous, as can be seen in FIG. 2, if the upper and lower cross member 2, 3 has ribbing 8, 9, so that the bulkhead 1 satisfies the requirements for stiffness and strength. Preferably, the ribbing 8 is configured in the manner of a cross on the upper cross member and extends over the entire cross member length or from the one inner A-pillar 4 to the opposing inner A-pillar 4. The lower cross member 3 preferably has ribbing 9, 10 in the direction of the passenger compartment G and in the direction of the front compartment F. The lower region of the side view of an inner A-pillar is shown in FIG. 3. It can be clearly seen therefrom that the receiving elements 5, 6 for the sill and the longitudinal member are configured to be C-shaped. This permits a positive attachment of the sill and longitudinal member to the bulkhead 1. The diagonal ribs 7 which run between the receiving elements 5, 6 are also visible, which provide the advantage of diverting the force.

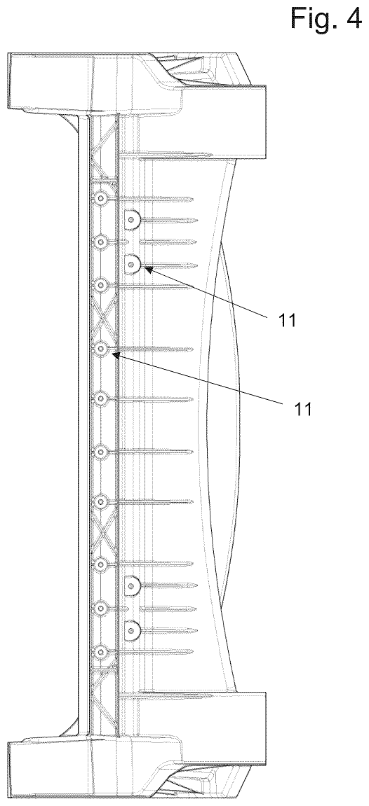

FIG. 4 shows the preferably integrated attachment elements 11 in order to attach a chassis sub-frame and/or a battery housing to the bulkhead 1 by joining. The attachment elements 11 are preferably configured as screw mounting points.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Bulkhead
2 Upper cross member
3 Lower cross member
4 Inner A-pillar
5 Sill receiving element
6 Longitudinal member receiving element
7 Diagonal rib
8 Upper cross member ribbing
9 Lower cross member ribbing on passenger compartment side
10 Lower cross member ribbing on front compartment side
11 Attachment elements
G Passenger compartment
F Front compartment

1. A bulkhead of a motor vehicle, wherein the bulkhead extends transversely to a vehicle direction and is configured to separate a passenger compartment and a front compartment, the bulkhead comprising:
an upper cross member;
two inner A-pillars which are arranged in each case to a side of the bulkhead;
sill receiving elements and longitudinal member receiving elements which are arranged in each case on the inner A-pillars; and
a lower cross member, the lower cross member and the bulkhead being configured as a one-piece or integral light metal pressure die-cast part.

2. The bulkhead according to claim 1, comprising at least one diagonal rib arranged between at least one of the sill receiving elements and at least one of the longitudinal member receiving elements.

3. The bulkhead according to claim 1, wherein the lower cross member is configured for attaching a battery housing and has attachment elements.

4. The bulkhead according to claim 1, wherein the lower cross member is configured for attaching a chassis sub-frame and has attachment elements.

5. The bulkhead according to claim 1, wherein the receiving element is C-shaped and configured to enclose the sill positively.

6. The bulkhead according to claim 1, wherein the receiving element is C-shaped and configured to enclose the longitudinal member positively.

7. The bulkhead according to claim 1, wherein the bulkhead is thin-walled with a thickness between 1 and 8 mm.

8. The bulkhead according to claim 1, wherein the lower cross member has ribbing configured for reinforcement.

9. The bulkhead according to claim 1, wherein the upper cross member has ribbing configured for reinforcement.

10. The bulkhead according to claim 1, wherein the bulkhead comprises an Al or Mg alloy.

11. A method for producing the bulkhead according to claim 1, comprising producing the bulkhead by pressure die-casting.
